(19) United States
(12) Patent Application Publication
(10) Pub. No.: US 2008/0147429 A1
(43) Pub. Date: Jun. 19, 2008

(54) METHOD AND SERVER FOR TRANSFERRING AN OWNERSHIP OF A PRODUCT VIA THE INTERNET

(75) Inventor: Kuanyu Chiang, Taipei (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: Chen-Kun Liu, Taipei (TW)

(21) Appl. No.: 11/957,961

(22) Filed: Dec. 17, 2007

(30) Foreign Application Priority Data
Dec. 19, 2006 (TW) 095147625

(51) Int. Cl. G06Q 50/00

(52) U.S. Cl. 705/1

(57) ABSTRACT

A method for transferring an ownership of a product through the Internet and a server is provided. The ownership originally belongs to an abandoner. The method comprises steps of: receiving a request of abandoning the product from the abandoner through the Internet; storing information of the product in response to the request; transmitting a message to inform the abandoner to indicate that assignment of the ownership has been accepted; publishing the information; receiving one pick-up condition from at least one picker through the Internet; generating a pick-up file in response to the pick-up condition; storing the pick-up file; deciding a final picker to have the ownership after a predetermined interval of time; and informing the final picker.

This application claims the benefits of priority based on Taiwan Patent Application No. 095147625 filed on Dec. 19, 2006, the disclosures of which are incorporated by reference herein.

### CROSS-REFERENCES TO RELATED APPLICATIONS

Not applicable.

### BACKGROUND OF THE INVENTION

1. Field of the Invention

The present invention relates to a method and a server for transferring an ownership of a product via the Internet. More particularly, the present invention relates to a method and a server for transferring an ownership of a product that has been abandoned.

2. Descriptions of the Related Art

Nowadays, rapid development of the Internet and the consequent e-commerce business are changing consumption styles of the modern people. Formerly, people have to go to a physical shop for any commodities they need. But now with the Internet, people may not only do online shopping but also conduct e-auction via the Internet.

For the current online shopping and e-auction websites, buyers, sellers, and the third parties all seek for profits. That is, buyers seek to buy commodities at the lowest prices, while the sellers seek to sell commodities at satisfactory prices. Furthermore, the third parties are destined to charge an agent commission or an advertisement fees.

In the modern wealthy society, people are more than satisfied with material needs. However, over-consumption is becoming increasingly serious, which results in underutilization of many products. In view of this, people with environmental protection awareness have begun to “contribute” products that they no longer need in attempt to help others without expectation for return. Accordingly, some nonprofit organizations have emerged to collect products that no longer needed by others (i.e., old clothes) and to give the products to people who need them.

However, such activities are not effective as a result of restricted territories. It could be a great contribution to the society if a nonprofit platform can be established through the Internet. People can abandon products voluntarily for those who need them. This may provide a way for people to recycle products that they want to discard and further to promote the idea of “plain but not luxury”.

### SUMMARY OF THE INVENTION

One objective of this invention is to provide a method for transferring an ownership of a product via the Internet, wherein the ownership originally belongs to an abandoner. The method comprises the steps of: receiving a request of abandoning the product from the abandoner via the Internet, wherein the request comprises an information of the product; storing the information of the product in response to the request; transmitting a message to the abandoner indicating that assignment of the ownership has been accepted; publishing the information of the product via the Internet; receiving a pick-up condition of at least one picker via the Internet; generating a pick-up record in response to the receipt of the pick-up condition; storing the pick-up record; assigning the ownership to a determined picker according to the at least one pick-up condition after a predetermined time interval, wherein the selected picker is one of the at least one picker; and informing the determined picker.

Another objective of this invention is to provide an ownership transferring method for a category of products, which comprises the steps of: (a) generating a plurality of abandon records, wherein the abandon records record an identity of each of a plurality of abandoners and an abandon batch number and a setting point of each of the abandoners; (b) generating a plurality of pick-up records, wherein the pick-up records record an identity of each of a plurality of pickers and a pick-up batch number and a pick-up point of each of the pickers; (c) calculating an average abandon point according to the abandon batch numbers and the setting points; (d) calculating an average pick-up point according to the pick-up batch numbers and the pick-up points; (e) calculating an absolute abandon difference value between the average abandon point and each of the setting points; (f) calculating an absolute pick-up difference value between the average pick-up point and each of the pick-up points; (g) ordering the abandoner records according to the absolute abandon difference values; (h) ordering the pick-up records according to the absolute pick-up difference values; and (i) transferring at least one ownership of the category of products according to the ordering of abandoners and the ordering of the pickers.

Yet a further objective of this invention is to provide a server for transferring an ownership of a product via the Internet, wherein the ownership originally belongs to an abandoner. The server comprises a storage unit, an input/output interface and a processing unit. The input/output interface is used for receiving a request of abandoning the product from the abandoner via the Internet, wherein the request comprises an information of the product. The processing unit is used for storing the information of the product in the storage unit in response to the request; transmitting a message to the abandoner through the input/output interface to indicate that assignment of the ownership has been accepted; publishing the information of the product via the Internet through the input/output interface; receiving a pick-up condition of at least one picker via the Internet through the input/output interface; generating a pick-up record in response to receipt of the pick-up condition; storing the pick-up record in the storage unit; assigning the ownership to a determined picker according to the at least one pick-up condition after a predetermined time interval, wherein the selected picker is one of the at least one picker; and inform the determined picker.

Still another objective of this invention is to provide an ownership transferring server for a category of products, which comprises an input/output interface and a processing unit. The input/output interface is used for the Internet to receive a plurality of requests to abandon the category of products and a plurality of requests to pick-up the category of products. The processing unit is used for: (a) generating a plurality of abandon records, wherein the abandon records record an identity of each of a plurality of abandoners, and an abandon batch number and a setting point of each of the abandoners; (b) generating a plurality of pick-up records, wherein the pick-up records record an identity of each of a plurality of pickers, and a pick-up batch number and a pick-up point of each of the pickers; (c) calculating an average abandon point according to the abandon batch numbers and the setting points; (d) calculating an average pick-up point according to the pick-up batch numbers and the pick-up points; (e) calculating an absolute abandon difference value between the average abandon point and each of the setting points; (f) calculating an absolute pick-up difference value between the average pick-up point and each of the pick-up points; (g) ordering the abandoner records according to the absolute abandon difference values; (h) ordering the pick-up records according to the absolute pick-up difference values; and (i) transferring at least one ownership of the category of products according to the ordering of abandoners and the ordering of the pickers.

According to this invention, a platform is provided via the Internet for users to abandon unnecessary products and transfer an ownership free of charge to those who need them to achieve using products efficiently.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 depicts a hardware configuration of an embodiment of this invention;

FIG. 2 depicts a flow diagram of a method of this invention;

FIG. 3 depicts a flow diagram of a process for an abandoner abandoning a product;

FIG. 4 depicts a flow diagram of a process for a picker picking up a product; and

FIG. 5 depicts a flow diagram of an ownership transferring method of this invention.

### DESCRIPTION OF THE PREFERRED EMBODIMENT

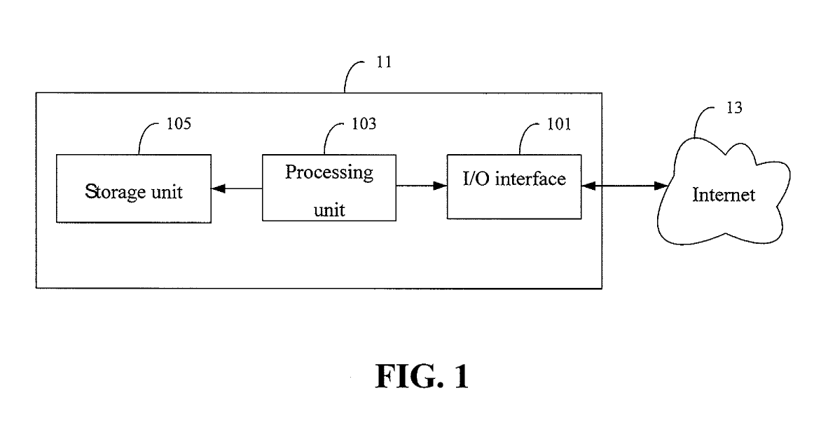

FIG. 1 depicts a hardware configuration of a network server 11 in accordance with a first embodiment of this invention. In more detail, the network server 11 is a nonspecific server comprising an input/output interface 101, a processing unit 103, and a storage unit 105. The input/output interface 101, which may be any of the current available and future network interfaces (e.g., an Ethernet card), is connected to the Internet 13. The processing unit 103, which may be any of the current available and future microprocessors and current available and future central processing units, is connected to the input/output interface 101. The storage unit 105 is connected to the processing unit 103, and can be a floppy disk, a hard disk, a compact disk, a mobile disk, a magnetic tape, a database accessible to networks, and any other storage media with the same function and well known to those skilled in the art.

The network server 11 is controlled by an application to execute a method for transferring an ownership of a product. More specifically, the network server 11 provides a platform for transferring the ownership. The storage unit 105 is used for storing available points of each user. When logging on the platform, a user is allowed to abandon or pick up a product. In other words, the ownership of the product registered on the platform will be transferred from an abandoner to a picker and the available points of the users will be adjusted accordingly.

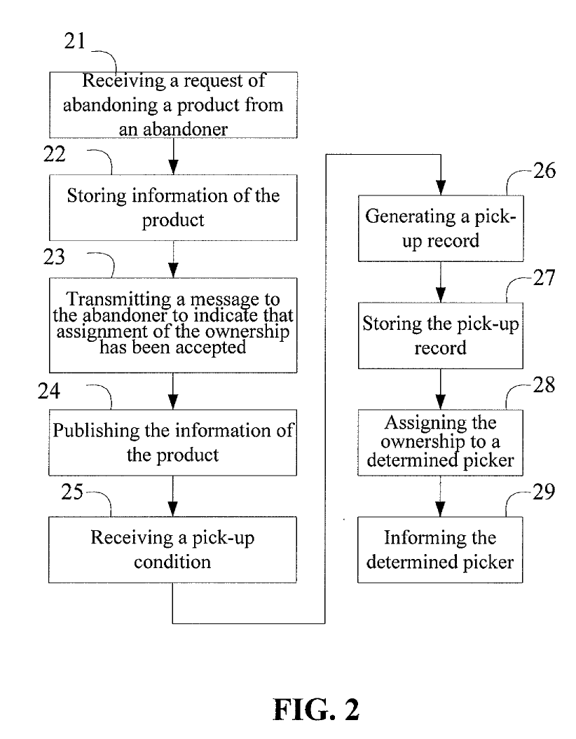

This method is depicted in FIG. 2. Initially in step 21, the server 11 receives a request of abandoning a product from an abandoner via the Internet 13. The request may comprise information of the product, including an identity of the abandoner, a category of the product, a total number of the product, an abandon batch number of the product, an abandon date, a status of the product, a picture of the product, etc. The abandon batch number of the product refers to a least number of each batch when products are abandoned in batches. It should be noted that, the request described herein refers to a request to “abandon” rather that to “auction” a product; in other words, such a request means that the abandoner is willing to abandon the ownership of this product.

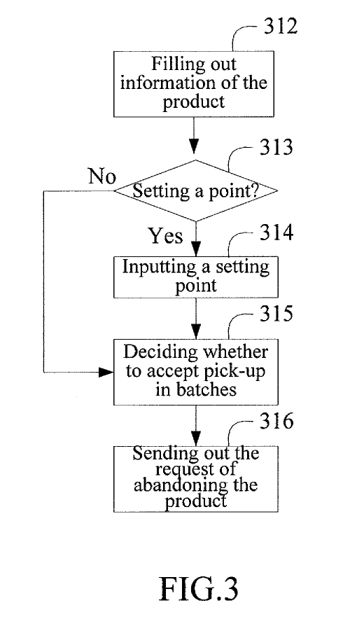

A flow diagram of a process for an abandoner to abandon a product is depicted in FIG. 3. In step 312, the abandoner submits information of the product through an e-mail or directly on a webpage of the platform. Then in step 313, the abandoner determines whether to set a point number, which represents a lowest point number that a potential picker has to contribute in order to pick up this product. If the abandoner chooses not to set a point number, the process proceeds directly to step 315, where the abandoner determines whether to allow pick-up of the products in batches in case a plurality of products are to be abandoned. If the abandoner chooses to set a point number in step 313, the user inputs a point number in step 314 before proceeding to step 315. In step 316, the abandoner fills out the information and sends out a request of abandoning the product.

Referring back to FIG. 2, next in step 22, the application controls the processing unit 103 to store the information in the storage unit 105 in response to the request. Subsequently in step 23, in response to the request, the application controls the processing unit 103 to transmit a message to the abandoner via the input/output interface 101 and the Internet, indicating that the platform has received the request and accepts assignment of the ownership. In other embodiments, the message may be a short message, and the short message will be sent to a mobile phone of the user. Thereafter, the application controls the processing unit 103 to publish the information via the input/output interface 101 and the Internet in step 24. Through inquiry or webpage browsing, network users could be informed that this product has been abandoned.

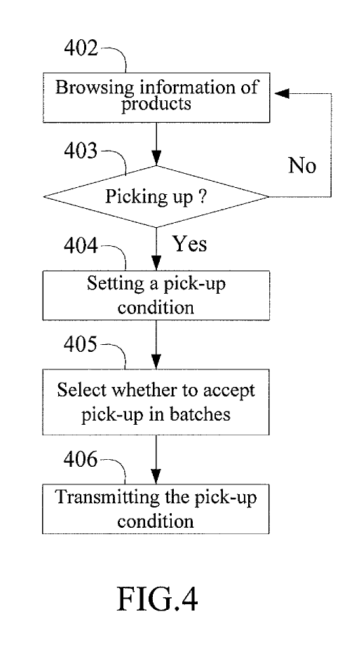

After publishing the information, the server 11 sets a predetermined time interval, within which anyone may express a desire to pick up this product via the Internet. A process for a picker to express such a desire is depicted in FIG. 4. In step 402, a network user logs on the server 11 to browse information of all products stored in the storage unit 105. Then in step 403, the network user decides whether to pick up a product that he or she is browsing. If not, then the process returns back to step 402 to browse another product. If the user decides to pick up the product in step 403, the process proceeds to step 404, where the user sets pick-up conditions, including an identity and pick-up points. Next in step 405, the user chooses whether to agree to pick up in batches in case the number he or she desires to pick up exceeds the number of products being abandoned. Finally in step 406, the user sends out the pick-up conditions, and upon the server 11 receiving the pick-up conditions, the user becomes a potential picker of the product.

Referring back to FIG. 2, in step 25, any of the potential pickers may transmit a pick-up condition to the server 11 via the Internet. The server 11 receives the pick-up condition (or pick-up conditions) via the Internet. Each pick-up condition comprises an identity of the corresponding potential picker, an abandon batch number and a pick-up point, wherein the abandon batch number refers to a least number of each batch when products have to be abandoned in batches. Next in step 26, the application controls the processing unit 103 to generate a pick-up record to record these pick-up conditions. Next in step 27, the application controls the processing unit 103 to store the pick-up record in the storage unit 105. After the predetermined time interval, in step 28, the application controls the processing unit 103 to retrieve the pick-up record for deciding which picker will be assigned to the ownership. Finally in step 29, the application controls the processing unit 103 to inform the determined picker via the input/output interface 101 and the Internet. In other embodiments, the determined picker may be informed by a short message transmitted to a mobile phone thereof.

A variety of rules for determining the selected picker apply in step 28. For example, the application controls the processing unit 103 to determine whether the abandoner is included in these potential pickers. If the answer is yes, it means that the abandoner regrets and wants the product back. Hence, the application controls the processing unit 103 to set the abandoner as the selected picker in order to return the ownership to the abandoner. If the abandoner is not included in the potential pickers, the application controls the processing unit 103 to transmit a message to the abandoner via the input/output interface 101 and the Internet, informing that the predetermined time interval has been ended and he has a priority to pick up the product. As this invention provides the abandoner an opportunity to withdraw the abandonment, the abandoner still has a priority over other pickers for picking-up the product back after the product has been abandoned. As a result, the abandoner will be more willing to abandon a product, thus promoting the chance to reuse the product. If the abandoner does abandon the ownership of the product, the application controls the processing unit 103 to determine if there is only one single picker according to the pick-up record. If the answer is yes, the single picker will be determined as the selected picker. Otherwise, if there are a plurality of pickers, the one having the most pick-up points will be determined as the selected picker.

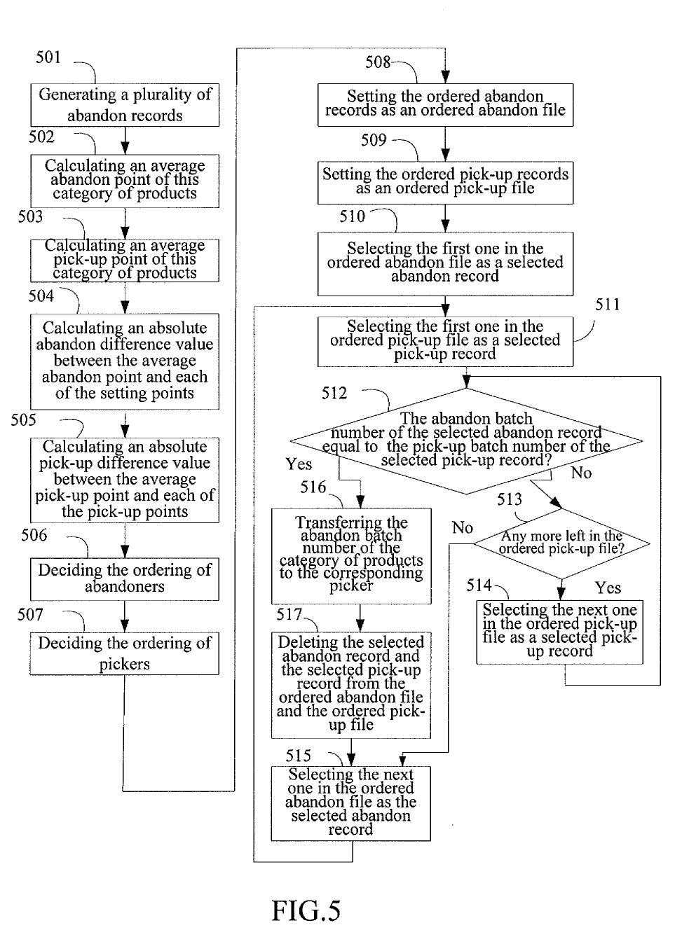

If more than one product is to be abandoned, the aforesaid pick-up condition will further include a desired number to pick up in addition to the identity of the picker and a pick-up point. In case there are a plurality of abandoners and a plurality of pickers simultaneously, a mechanism has to be provided in the platform to decide the ownership of the products. FIG. 5 depicts a flow diagram for transferring an ownership in step 28 in such a case.

It is assumed that there are two abandoners abandoning cups, with information thereof being shown in Table I below.

TABLE I

| Identity of the | Total number to | Abandon | Setting |
|---|---|---|---|
| abandoner | be abandoned | batch number | point |
| A | 4 | 2 | 15 |
| B | 3 | 1 | 20 |

It is assumed that there are two potential pickers, with information thereof being shown in Table II below, and the pick-up record stored into the storage unit 105 in step 27 being shown in Table III below.

TABLE II

| Identity of the | Desired number | Pick-up batch | Pick-up |
|---|---|---|---|
| picker | to pick up | number | point |
| C | 3 | 1 | 12 |
| D | 2 | 2 | 17 |

TABLE III

| Identity of the | Pick-up batch | Pick-up |
|---|---|---|
| picker | number | point |
| C | 1 | 12 |
| C | 1 | 12 |
| C | 1 | 12 |
| D | 2 | 17 |

In step 501, the application controls the processing unit 103 to generate a plurality of abandon records as shown in Table IV below according to the information of Table I stored in the storage unit 105. The way to generate the abandon records depends on the abandon batch number preset by the abandoner. Each of the abandon records includes identity of the corresponding abandoner, the abandon batch number of this category of products (not larger than the abandon batch number) and the setting points of this category of products.

TABLE IV

| Identity of the | Abandon | Abandon |
|---|---|---|
| abandoner | batch number | point |
| A | 2 | 15 |
| A | 2 | 15 |
| B | 1 | 20 |
| B | 1 | 20 |
| B | 1 | 20 |

Next, the application controls the processing unit 103 to calculate an average abandon point according to the abandon batch numbers and the setting points in step 502, and calculate an average pick-up point according to the pick-up batch numbers and the pick-up points in step 503. Here, the average abandon point is 17.14 and the average pick-up point is 14, and both of them are stored in the storage unit 105.

Then in step 504, the application controls the processing unit 103 to calculate an absolute abandon difference value between the average abandon point and each of the setting points of the abandon records, with the results being 2.14, 2.14, 2.86, 2.86 and 2.86 respectively. In step 505, the application controls the processing unit 103 to calculate an absolute pick-up difference value between the average pick-up point and each of the pick-up points of the abandon records, with the results being 2, 2, 2, and 3 respectively.

Then the application controls the processing unit 103 to order the abandoner according to the absolute abandon difference values and order the pickers according to the absolute pick-up difference values in step 506 and step 507 respectively. Specifically, these abandon records are ordered from the smallest to the largest according to the absolute abandon difference values. As the absolute abandon difference values are 2.14, 2.14, 2.86, 2.86 and 2.86 respectively, the abandoners still have the same order as shown in Table IV. Similarly, in order to order the pickers, these pick-up records are ordered from the smallest to the largest according to the absolute pick-up difference values. As the absolute pick-up difference values are 2, 2, 2, and 3 respectively, the pickers still have the same order as shown in Table III.

Then in step 508, the application controls the processing unit 103 to set the ordered abandon records as an ordered abandon file and store it into the storage unit 105. In step 509, the application controls the processing unit 103 to set the ordered pick-up records as an ordered pick-up file and store it into the storage unit 105.

Subsequently, in step 510, the application controls the processing unit 103 to select the first one in the ordered abandon file from the storage unit 105 as a selected abandon record, i.e. (A, 2, 15). In step 511, the application controls the processing unit 103 to select the first one in the ordered pick-up file from the storage unit 105 as a selected pick-up record, i.e. (C, 1, 12). In step 512, the application controls the processing unit 103 to determine whether the abandon batch number of the selected abandon record is equal to the pick-up batch number of the selected pick-up record. Herein, as the abandon batch number is 2 and the pick-up batch number is 1, i.e. they are not equal. Accordingly, the application controls the processing unit 103 to determine whether there are any more pick-up records in the ordered pick-up file in step 513. Here, there are still three pick-up records left in the ordered pick-up file. So in step 514, the application controls the processing unit 103 to select the next one in the ordered pick-up file as the selected pick-up record, which is still (C, 1, 12). The process returns back to step 512. At this point, as the pick-up batch number of the selected pick-up record is still not equal to the abandon batch number of the selected abandon record, the above steps are repeated again. If the answer of step 513 is no, then there is no more pick-up record left in the ordered pick-up file. In this case, the process proceeds to step 515, where the application controls the processing unit 103 to select the next one in the ordered abandon file as the selected abandon record, and the process returns back to step 511.

Until the (D, 2, 17) is selected as the selected pick-up record, the pick-up batch number is equal to the abandon batch number (i.e., both having a value of 2). Then in step 516, the application controls the processing unit 103 to transfer an ownership of the abandon batch number of cups to the picker corresponding to the selected pick-up record, i.e., the picker D is set as the selected picker. Accordingly, the setting point of D is deducted by the average pick-up point, while that of the abandoner A is added. Then in step 517, the selected abandon record and the selected pick-up record are deleted from the ordered abandon file and the ordered pick-up file by the processing unit 103.

According to the steps shown in FIG. 5, an ownership of a product may be transferred among multiple abandoners and multiple pickers on a fair basis without chance for deliberate speculation. More importantly, this method let an abandoner to “abandon” unnecessary products completely. Therefore, this invention is expected to make people more willing to exchange products. Moreover, this method is also suitable for use in common transaction platforms, in which case the abandoner is known as the seller, the picker is known as the buyer, and the point corresponds to transaction amount. Therefore, any common transaction platforms utilizing the method of this invention also fall within scope of the claims of this invention.

The purpose to set points is to promote an idea of “no abandoning actions, no pick-ups”, and to prevent some people from picking up products to sell although they have already had such products. Therefore, the points have nothing to do with value of a product, and may be set as desired by an abandoner or a picker. Hence, the spirit of this invention is to contribute unnecessary products to others, which is different in essence from conventional transaction websites with a goal of earning profits.

The aforesaid application may be stored in the data storage unit 105 or other tangible machine-readable media, such as a floppy disk, a hard disk, a compact disk, a mobile disk, a magnetic tape, a database accessible to networks, or any other storage media with the same function and well known to those skilled in the art.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A method for transferring an ownership of a product via the Internet, the ownership belonging to an abandoner, the method comprising the steps of:
receiving a request of abandoning the product from the abandoner via the Internet, the request comprising an information of the product;
storing the information of the product in response to the request;
transmitting a message to the abandoner indicating assignment of the ownership has been accepted;
publishing the information of the product via the Internet;
receiving a pick-up condition of at least one picker via the Internet;
generating a pick-up record in response to the receipt of the pick-up condition;
storing the pick-up record;
assigning the ownership to a determined picker according to the at least one pick-up condition after a predetermined time interval, the determined picker being one of the at least one picker; and
informing the determined picker.

2. The method of the claim 1, wherein the information of the product comprises one of an identity of the abandoner, a category of the product, a number of the product, an abandon date of the product, a status of the product, a picture of the product, and the combination thereof.

3. The method of the claim 1, wherein each of the at least one pick-up condition comprises an identity of the corresponding picker and a number of pick-up points.

4. The method of the claim 1, further comprising the step of:
determining that the abandoner is one of the at least one picker;
wherein the determined picker is the abandoner.

5. An ownership transferring method for a category of products, comprising the steps of:
(a) generating a plurality of abandon records, the abandon records recording an identity of each of a plurality of abandoners and an abandon batch number and a setting points of each of the abandoners;
(b) generating a plurality of pick-up records, the pick-up records recording an identity of each of a plurality of pickers and a pick-up batch number and a pick-up point of each of the pickers;
(c) calculating an average abandon point according to the abandon batch numbers and the setting points;
(d) calculating an average pick-up point according to the pick-up batch numbers and the pick-up points;
(e) calculating an absolute abandon difference value between the average abandon point and each of the setting points;
(f) calculating an absolute pick-up difference value between the average pick-up point and each of the pick-up points;
(g) ordering the abandoner records according to the absolute abandon difference values;
(h) ordering the pick-up records according to the absolute pick-up difference values; and
(i) transferring at least one ownership of the category of products according to the ordering of abandoners and the ordering of the pickers.

6. The method of the claim 5, wherein the step (i) comprises the steps of:
(j) setting the result of step (g) as an ordered abandon file;
(k) setting the result of step (h) as an ordered pick-up file;
(l) selecting the first one in the ordered abandon file as a selected abandon record;
(m) selecting the first one in the ordered pick-up file as a selected pick-up record;
(n) determining the abandon batch number of the selected abandon record being equal to the pick-up batch number of the selected pick-up record; and
(o) transferring the ownership of each of the abandon batch number of the category of products to the picker corresponding to the selected pick-up record.

7. The method of the claim 5, wherein the step (i) comprises the steps of:
(j) setting the result of step (g) as an ordered abandon file;
(k) setting the result of step (h) as an ordered pick-up file;
(l) selecting the first one in the ordered abandon file as a selected abandon record;
(m) selecting the first one in the ordered pick-up file as a selected pick-up record;
(n) determining the abandon batch number of the selected abandon record being different from the pick-up batch number of the selected pick-up record;
(o) selecting the next one in the ordered pick-up file as the selected pick-up record;
(p) determining the abandon batch number of the selected abandon record being equal to the pick-up batch number of the selected pick-up record after the step (o); and
(q) transferring the ownership of each of the abandon batch number of the category of products to the picker corresponding to the selected pick-up record after the step (p).

8. The method of the claim 5, further comprising the steps of:
(j) setting the result of step (g) as an ordered abandon file;
(k) setting the result of step (h) as an ordered pick-up file;
(l) selecting the first one in the ordered abandon file as a selected abandon record;
(m) selecting the first one in the ordered pick-up file as a selected pick-up record;
(n) determining the abandon batch number of the selected abandon record being different from the pick-up batch number of the selected pick-up record;
(o) determining that the ordered pick-up file has no next one;
(p) selecting the next one in the ordered abandon file as the selected abandon record;
(q) selecting the first one in the ordered pick-up file as the selected pick-up record after the step (p);
(n) determining the abandon batch number of the selected abandon record being equal to the pick-up batch number of the selected pick-up record after the step (q); and
(o) transferring the ownership of each of the abandon batch number of the category of products to the picker corresponding to the selected pick-up record after the step (n).

9. A server for transferring an ownership of a product via the Internet, the ownership belonging to an abandoner, the server comprising:
a storage unit;
an input/output interface for receiving a request of abandoning the product from the abandoner via the Internet, the request comprising an information of the product; and
a processing unit for storing the information of the product in the storage unit in response to the request, for transmitting a message to the abandoner through the input/output interface, the message indicating assignment of the ownership has been accepted, for publishing the information of the product via the Internet through the input/output interface, for receiving a pick-up condition of at least one picker via the Internet through the input/output interface, for generating a pick-up record in response to the receipt of the pick-up condition, for storing the pick-up record in the storage unit, for assigning the ownership to a determined picker according to the at least one pick-up condition after a predetermined time interval, the determined picker being one of the at least one picker, and for informing the determined picker.

10. The server of the claim 9, wherein the information of the product comprises one of an identity of the abandoner, a category of the product, a number of the product, an abandon date of the product, a status of the product, a picture of the product, and the combination thereof.

11. The server of the claim 9, wherein each of the at least one pick-up condition comprises an identity of the corresponding picker and a number of pick-up points.

12. The server of the claim 9, wherein the processing unit determines that the abandoner is one the at least one picker and wherein the determined picker is the abandoner.

13. An ownership transferring server for a category of products, comprising:
an input/output interface, connected to the Internet for receiving a plurality of requests for abandoning the category of products and a plurality of requests for picking-up the category of products; and
a processing unit for:
(a) generating a plurality of abandon records, the abandon records recording an identity of each of a plurality of abandoners and an abandon batch number and a setting point of each of the abandoners,
(b) generating a plurality of pick-up records, the pick-up records recording an identity of each of a plurality of pickers and a pick-up batch number and a pick-up point of each of the pickers,
(c) calculating an average abandon point according to the abandon batch numbers and the setting points,
(d) calculating an average pick-up point according to the pick-up batch numbers and the pick-up points,
(e) calculating an absolute abandon difference value between the average abandon point and each of the setting points,
(f) calculating an absolute pick-up difference value between the average pick-up point and each of the pick-up points,
(g) ordering the abandoner records according to the absolute abandon difference values,
(h) ordering the pick-up records according to the absolute pick-up difference values, and
(i) transferring at least one ownership of the category of products according to the ordering of abandoners and the ordering of the pickers.

14. The ownership transferring server of the claim 13, wherein the processing unit further (j) sets the result of step (g) as an ordered abandon file, (k) sets the result of step (h) as an ordered pick-up file, (l) selects the first one in the ordered abandon file as a selected abandon record, (m) selects the first one in the ordered pick-up file as a selected pick-up record, and (n) determines the abandon batch number of the selected abandon record being equal to the pick-up batch number of the selected pick-up record, and (o) transfers the ownership of each of the abandon batch number of the category of products to the picker corresponding to the selected pick-up record, in order to transfer the at least one ownership of the category of products according to the ordering of abandoners and the ordering of the pickers.

15. The ownership transferring server of the claim 13, wherein the processing unit further (j) sets the result of step (g) as an ordered abandon file, (k) sets the result of step (h) as an ordered pick-up file, (l) selects the first one in the ordered abandon file as a selected abandon record, (m) selects the first one in the ordered pick-up file as a selected pick-up record, (n) determines the abandon batch number of the selected abandon record being different from the pick-up batch number of the selected pick-up record, (o) selects the next one in the ordered pick-up file as the selected pick-up record, (p) then determines the abandon batch number of the selected abandon record being equal to the pick-up batch number of the selected pick-up record, and (q) then transfers the ownership of each of the abandon batch number of the category of products to the picker corresponding to the selected pick-up record, in order to transfer the at least one ownership of the category of products according to the ordering of abandoners and the ordering of the pickers.

16. The ownership transferring server of the claim 13, wherein the processing unit further (j) sets the result of step (g) as an ordered abandon file, (k) sets the result of step (h) as an ordered pick-up file, (l) selects the first one in the ordered abandon file as a selected abandon record, (m) selects the first one in the ordered pick-up file as a selected pick-up record, (n) determines the abandon batch number of the selected abandon record being different from the pick-up batch number of the selected pick-up record, (o) determines that the ordered pick-up file has no next one, (p) selects the next one in the ordered abandon file as the selected abandon record, (q) then selects the first one in the ordered pick-up file as the selected pick-up record, (n) then determines the abandon batch number of the selected abandon record being equal to the pick-up batch number of the selected pick-up record, and (o) then transfers the ownership of each of the abandon batch number of the category of products to the picker corresponding to the selected pick-up record.
